(19) United States
(12) Patent Application Publication
(10) Pub. No.: US 2026/0320595 A1
(43) Pub. Date: Oct. 15, 2026

(54) INTERACTION DATA CALIBRATION AND PROJECTION

(71) Applicant: ABCS INSIGHTS Inc., Kissimmee, FL (US)

(72) Inventors: Jerome Shimizu, Kissimmee, FL (US); Michael Sheng, Orlando, FL (US)

(21) Appl. No.: 19/293,858

(22) Filed: Aug. 7, 2025

Related U.S. Application Data
(60) Provisional application No. 63/787,473, filed on Apr. 11, 2025.

(51) Int. Cl. G06Q 20/38; G06Q 20/32; G06Q 20/40

(52) U.S. Cl. CPC G06Q 20/389; G06Q 20/3224; G06Q 20/4015

(57) ABSTRACT

A system and method for calibrating electronic interaction data uses transaction log data to improve behavioral accuracy and reduce reporting bias. The system accesses electronic interaction data, such as digital receipts, and separately accesses transaction log data, such as credit card records, for a given user. By comparing the number of interactions recorded in each data source, the system identifies discrepancies and determines a projection factor that reflects the gap in reporting. The projection factor is applied to the electronic interaction data to generate a calibrated dataset that more accurately reflects user behavior. The system may apply different projection factors by user, merchant, region, or product type. Machine learning models may be used to detect reporting inconsistencies, infer missing data, and assign confidence scores. The calibrated dataset can be used for downstream analytics, including market penetration, purchase frequency, and audience segmentation with greater accuracy and reduced data bias.

### CLAIM OF PRIORITY

This application claims the benefit of priority to U.S. Provisional Application Ser. No. 63/787,473, filed on Apr. 11, 2025, which is incorporated herein by reference in its entirety.

### BACKGROUND

Ad exposure technology measures whether and how consumers interact with advertisements across various mediums, including digital, out-of-home, in-store, and broadcast channels. These systems estimate ad reach and effectiveness. Ad exposure technology plays a crucial role in advertising analytics by tracking when, where, and how consumers encounter advertisements across multiple platforms. These technologies help attribute conversions to specific marketing touchpoints, distinguishing between direct and indirect influences on consumer behavior.

### BRIEF SUMMARY

Some embodiments pertain to innovative systems and methodologies for using calibration models to project complete consumer purchase behavior, even when only partial receipt data is available. By integrating transaction data across diverse sources and applying projection factors based on observed discrepancies, the system adjusts for missing receipts, demographic bias, retailer-specific reporting gaps, and variations in consumer reporting behavior.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an example system architecture for calibrating electronic interaction data using transaction log data, according to some implementations.

FIG. 2 illustrates an example method for interaction data calibration and projection, according to some examples.

FIG. 3 illustrates an example in which the interaction calibration system calibrates receipt data associated with a user, according to some examples.

FIG. 4 illustrates a system architecture that enables the calibration of electronic interaction data using multiple sources of transaction log data, and applies the resulting calibrated dataset to drive targeted advertising campaigns, retargeting strategies, and media placement decisions, according to some examples.

FIG. 5 is a diagrammatic representation of a machine in the form of a computer system within which a set of instructions may be executed to cause the machine to perform any one or more of the methodologies discussed herein, according to some examples.

FIG. 6 is a block diagram showing a software architecture within which examples may be implemented.

FIG. 7 illustrates a machine-learning pipeline, according to some examples.

FIG. 8 illustrates training and use of a machine-learning program, according to some examples.

### DETAILED DESCRIPTION

Conventional consumer analytics systems that rely solely on electronic receipt data—such as user-scanned receipts or email-parsed digital receipts—are often incomplete and biased. These systems depend on consumers to actively submit or capture purchase data, which introduces inconsistencies, missing entries, and demographic skews in the dataset. For example, certain user groups may be more diligent in scanning receipts, while others may fail to submit them due to forgetfulness, lack of incentive, or technical issues. As a result, insights generated from this raw receipt data may not accurately represent true market behavior, leading to flawed segmentation, biased penetration estimates, and suboptimal decision-making.

One of the fundamental problems with relying solely on receipt data is the inability to detect missing interactions. If a consumer makes ten store visits but only submits receipts for three, the system has no way of knowing that seven interactions are missing. This partial visibility distorts behavior models, underestimates product or brand loyalty, and fails to capture the full spectrum of shopping frequency or product usage patterns. Such gaps are particularly problematic in high-frequency retail environments like grocery or convenience stores, where consumers often make routine purchases that go unrecorded.

Additionally, traditional systems that do not incorporate credit card or bank transaction data are unable to quantify how incomplete the receipt data truly is. Without an independent baseline of consumer activity, such as a transaction log that shows all spending activity across merchants, there is no reliable reference point to project the actual volume of missing data. As a result, these systems resort to probabilistic models or population-level estimates that fail to personalize corrections for individual consumers or geographies, thereby reducing the effectiveness of any downstream insights.

The interaction calibration system disclosed herein overcomes these limitations by integrating receipt data with external transaction log data—such as credit card records or bank-level purchase histories—to identify discrepancies and compute personalized projection factors. Unlike traditional approaches, this system does not assume receipt data is complete; instead, it uses independent, high-fidelity transaction logs to determine how many real-world interactions were missed by the receipt system. For example, if a user made eight transactions at a retailer according to their credit card log but only submitted three receipts, the system infers a missing data gap and calculates a projection factor of approximately 2.67×.

The system then applies this projection factor to scale the user's observed receipt data, creating a calibrated interaction dataset that more accurately reflects their true behavior. This calibration process can be executed at various levels of granularity—individual users, households, zip codes, or designated market areas (DMAs)—allowing analysts and marketers to draw conclusions with much greater confidence. For instance, brand penetration can be measured not just from partial receipt data but from a corrected dataset that approximates true consumer exposure, frequency, and product loyalty.

Moreover, the system supports data fusion across multiple sources and modalities. It can normalize receipt data from diverse channels (e.g., email-scraped, app-uploaded, or OCR-scanned paper receipts) and compare it against structured transaction logs from different financial institutions. Even when these data sources are formatted differently or originate from non-communicating systems, the system harmonizes them into a unified schema, detects overlap or missing entries, and recalibrates accordingly. The result is a more complete and unbiased dataset, capable of supporting advanced behavioral analysis, targeting, and performance measurement.

Finally, this system allows calibrated datasets to feed into downstream marketing operations, including targeting optimization, retargeting strategies, consumer segmentation, and inventory forecasting. By grounding insights in a more complete view of user behavior, businesses can improve the precision of decision-making while reducing reliance on guesswork or biased datasets. The interaction calibration system thus enables a more accurate, scalable, and data-rich foundation for consumer intelligence and market measurement.

### ARCHITECTURE FOR INTERACTION CALIBRATION AND PROJECTION FACTOR GENERATION

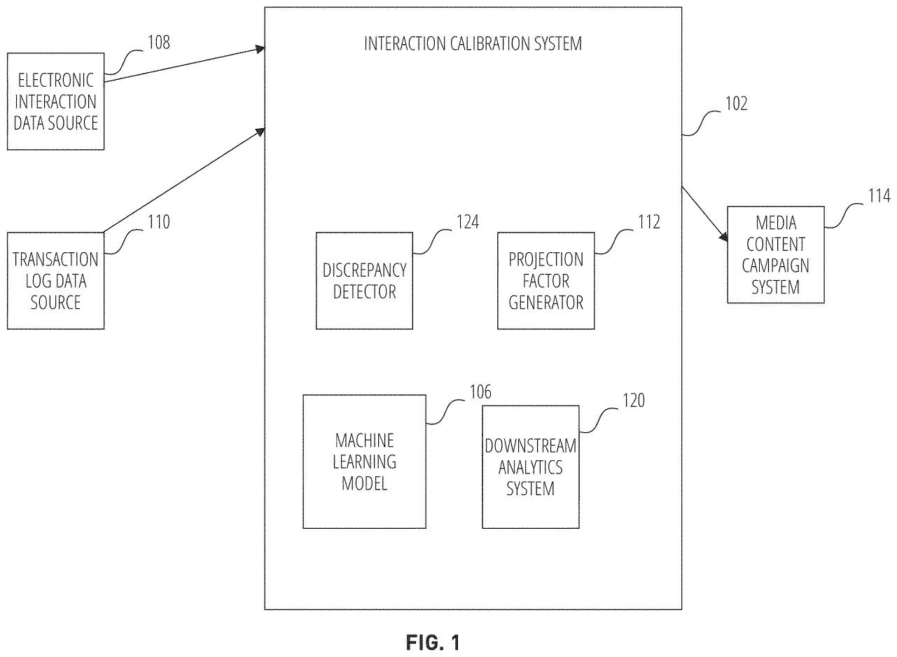

FIG. 1 illustrates an example system architecture for calibrating electronic interaction data using transaction log data, according to some implementations. The system includes an interaction calibration system 102 that receives data from an electronic interaction data source 108 and a transaction log data source 110. The electronic interaction data source 108 may provide data such as digital receipts, mobile app engagement logs, or in-store device interactions, while the transaction log data source 110 may provide aggregated records from credit card networks, banks, or other payment processors.

The interaction calibration system 102 includes several internal components for processing and reconciling the data. A discrepancy detector 124 identifies mismatches or underreporting between the interaction data and transaction logs. A projection factor generator 112 computes correction values—referred to as projection factors—that account for incomplete sampling or missing interaction records. A machine learning model 106 may be used to infer these projection factors based on historical patterns or contextual metadata. A downstream analytics system 120 within the calibration system may consume the calibrated interaction dataset to generate campaign insights, scoring outputs, or aggregated statistics. The resulting calibrated data is transmitted to a media content campaign system 114, which may use the information to optimize ad targeting, adjust campaign bidding strategies, or retarget consumers based on more accurate interaction histories.

The electronic interaction data source 108 provides records of user behavior that are captured through direct or indirect electronic interactions with retail environments, digital interfaces, or media platforms. This data may include scanned receipts, mobile app engagement logs, loyalty card activity, in-store kiosk interactions, QR code scans, or other device-based inputs that reflect a user's purchase intent or product-level engagement. In some implementations, the data source may include item-level metadata such as product identifiers, store locations, and timestamps. These interaction records may be sourced from first-party retailer systems or third-party aggregators and are typically tied to a pseudonymous user identifier (e.g., hashed email or device ID). While these sources provide high granularity, they are often incomplete due to user opt-out, technical limitations, or inconsistent data integration. As such, the electronic interaction data source 108 provides the primary—but potentially underreported—set of records that the system seeks to calibrate.

The transaction log data source 110 provides structured payment-level records from financial systems such as credit card processors, banks, or other payment gateways. These logs may include purchase timestamps, total transaction amounts, merchant category codes (MCCs), store identifiers, and location data. Unlike the electronic interaction data, transaction logs are generally complete and capture all qualifying transactions made by a user through a specific payment method. However, these logs typically lack product-level detail and cannot, on their own, identify the specific items or brands purchased. In some implementations, transaction log data may be linked to user identifiers via hashed account numbers or anonymized payment tokens. The transaction log data source 110 serves as a baseline reference that the system uses to detect discrepancies in the electronic interaction dataset. By comparing these two sources, the system can identify underreported interactions and generate projection factors to correct for data incompleteness.

The interaction calibration system 102 receives user-level data from both an electronic interaction data source and a transaction log data source and processes these inputs to generate a calibrated interaction dataset. This system analyzes discrepancies between the two datasets—where interaction data may underreport actual user purchases due to opt-outs, technical failures, or sampling limitations—and computes projection factors to correct for such underreporting. In some implementations, the system applies statistical analysis, rule-based logic, or machine learning techniques to infer the likelihood and magnitude of missing interactions. The goal of the interaction calibration system 102 is to produce a more complete and accurate representation of user behavior by reconciling inconsistencies between the datasets. This calibrated output can then be used by downstream systems to power more reliable analytics, targeting, and measurement workflows.

The media content campaign system 114 receives calibrated interaction data from the interaction calibration system and uses it to inform and optimize advertising campaigns. By leveraging a more complete view of user purchase behavior, this system can refine audience segmentation, personalize media content delivery, and improve bidding strategies for both digital and physical ad channels. In some implementations, the media content campaign system 114 dynamically adjusts campaign parameters—such as budget allocation, targeting criteria, or creative messaging—based on the updated insights. The system may also be used for retargeting users who engaged but did not convert, or for suppressing users who have already completed a transaction. By using the calibrated dataset as a foundation, the media content campaign system 114 enables more accurate campaign performance measurement and drives better return on ad spend (ROAS) across platforms.

The discrepancy detector 124 identifies mismatches between records from the electronic interaction data source and the transaction log data source for a given user or cohort. It compares characteristics such as transaction timestamps, merchant locations, and aggregated purchase volumes across the two datasets to determine whether certain transactions appear in the transaction logs but are missing or underreported in the electronic interaction data. In some implementations, the discrepancy detector 124 uses rule-based comparisons or statistical heuristics to flag gaps in item-level coverage, category-level consistency, or temporal alignment. This component produces a discrepancy signal that represents the scope and nature of underreporting, which is then used as input for downstream projection factor generation. The output may include user-level or segment-level discrepancy scores that quantify the degree of interaction data incompleteness.

The projection factor generator 112 uses the discrepancy signals identified by the system to compute correction values—referred to as projection factors—that estimate how much the electronic interaction data should be adjusted to better reflect the complete behavior indicated in the transaction logs. These projection factors may be determined based on predefined rules, historical adjustment ratios, or output from a predictive model. In some implementations, projection factors may be applied at different levels of granularity, such as per user, product category, store, or time window. The resulting projection factor represents a multiplier or adjustment value that can be used to inflate, weight, or normalize the incomplete interaction dataset. This enables downstream applications to operate on a version of the data that more accurately reflects the user's actual engagement or purchase behavior, despite gaps in the original interaction logs.

The machine learning model 106 may be used in some implementations of the interaction calibration system to infer projection factors or classify data completeness when explicit discrepancy signals are sparse or noisy. This model is trained on historical pairs of interaction data and transaction logs to learn patterns associated with underreporting. It may use features such as user behavior patterns, merchant metadata, purchase timing, and interaction frequency to predict likely interaction volume or detect latent discrepancies. In cases where rule-based methods fall short—such as in cold-start scenarios or with partial data—the machine learning model 106 provides a probabilistic estimate of the projection factor needed to align the datasets. This model improves over time through supervised learning, enabling the system to generalize across merchant types, regions, or campaign contexts.

The downstream analytics system 120 consumes the calibrated interaction dataset—whether adjusted through rule-based projection factors or machine learning predictions—and derives actionable insights for use in campaign execution, measurement, or reporting. This component may compute user-level or cohort-level statistics, such as category engagement rates, estimated sales lift, or visit frequency. In some implementations, it produces targeting lists, user scores, or audience segments that are passed to the media content campaign system for activation. The downstream analytics system 120 ensures that the benefit of calibrated data extends beyond attribution alone and into the broader marketing and measurement ecosystem, enhancing the accuracy of decisions made on top of incomplete or noisy behavioral datasets.

### INTERACTION DATA CALIBRATION AND PROJECTION

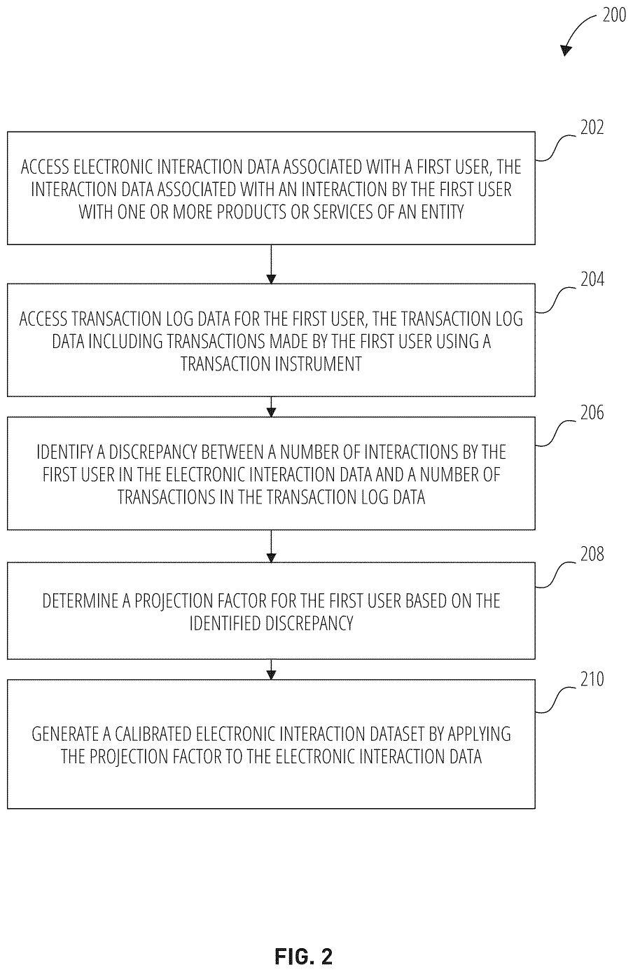

FIG. 2 illustrates an example method 200 for interaction data calibration and projection, according to some examples. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

In some embodiments, the interaction data may include receipt data, such as digital or image-based records of product purchases submitted through consumer-facing applications. However, interaction data is not limited to receipts. Interaction data can include other types of consumer-product engagement signals that reflect direct or indirect interactions with a merchant or brand.

For example, interaction data may comprise digital order confirmations received via email or app, loyalty program logs showing in-store check-ins or reward redemptions, QR code scans for promotional items, barcode scans through shopping apps, or itemized transaction summaries from online e-commerce platforms. In some cases, interaction data may include inferred purchases from geolocation-triggered store visits, mobile app-based product browsing behavior, or linked digital wallet activities.

In some embodiments, the transaction log data may include credit card history data, such as itemized or non-itemized transaction records obtained from financial institutions, card networks, or bank account aggregators. Transaction log data is not limited to traditional credit card statements.

Transaction log data may include debit card records, buy-now-pay-later (BNPL) payment activity, mobile wallet transactions, or direct bank transfers associated with point-of-sale systems. In some cases, transaction log data may include anonymized summaries of consumer-level financial activity derived from financial APIs or banking data platforms.

In some embodiments, the transaction instrument comprises a credit card used by the user to complete a transaction, and credit card records are accessed from financial systems or banking APIs. However, the transaction instrument is not limited to credit cards. A transaction instrument may include other forms of payment methods such as debit cards, store-branded loyalty cards, digital payment accounts, mobile wallets, or payment tokens used in encrypted or anonymized environments. In some cases, the transaction instrument may represent a bank account number used for ACH or direct deposit payments, or a virtual card issued for one-time purchases.

At block 202, the interaction calibration system accesses electronic interaction data associated with a first user. The interaction data can be associated with an interaction by the first user with one or more products or services of an entity.

The interaction data can represent observable behaviors that suggest a user engaged with one or more products or services of a given entity, such as a retailer, restaurant, or service provider. The interaction data can include traditional receipt records. However, it is appreciate that the system supports one or more other interaction data types.

In some embodiments, interaction data may include digitized receipts that are collected directly from retailer email confirmations, point-of-sale (POS) system integrations, mobile shopping apps, or third-party receipt aggregation services. These receipts can be structured in formats such as JSON, XML, or proprietary log schemas, and may contain detailed line items, timestamps, merchant identifiers, store locations, product SKUs, pricing, and discounts.

In other implementations, the interaction data may also include scanned images of physical receipts that have been processed using optical character recognition (OCR) to convert text-based content into structured, searchable data. For example, a user might upload a photo of their paper grocery store receipt, which the system parses to extract merchant and product-level information.

Beyond receipt-based interactions, the interaction calibration system can also ingest alternative forms of consumer interaction data. This may include digital check-in logs from loyalty programs (e.g., a user scanning a store loyalty card at checkout), item scanning data captured through mobile coupon redemptions, app-based shopping list behavior (e.g., adding or crossing off items), or interaction data from voice-activated purchase assistants and smart devices. These types of engagement signals, while not always accompanied by full receipt records, still provide useful indicators of product consideration or intent, and are therefore processed as valid interaction data within the system.

The interaction data accessed at this stage is associated with a specific user and may be linked to that user through anonymized identifiers, hashed device IDs, or loyalty account numbers. By preserving linkage at the individual user level, the system enables personalized behavioral analysis and avoids aggregating behavior across unrelated consumers. This is especially critical in calibration contexts, as identifying and adjusting for missing data relies on comparing interaction behaviors for known users across multiple systems.

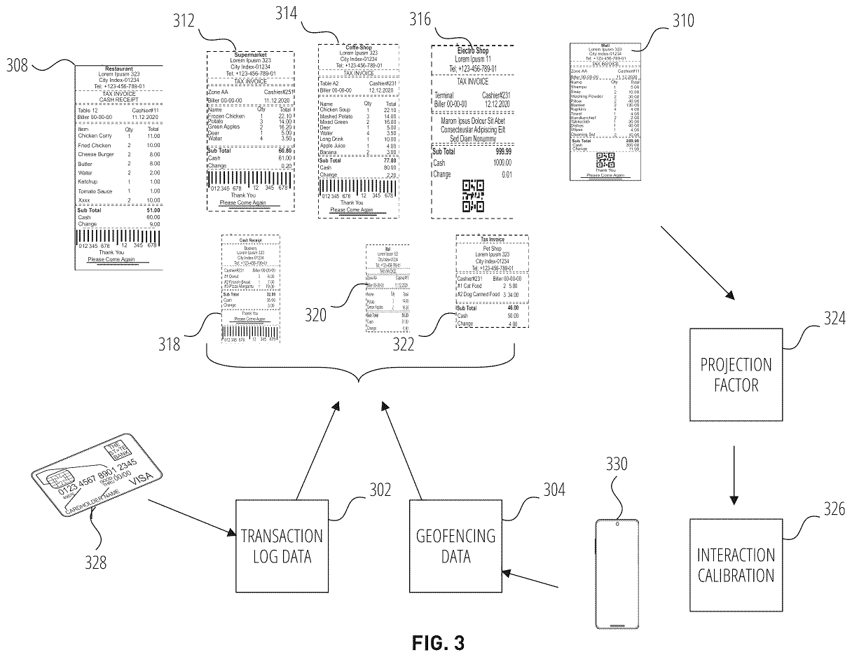

FIG. 3 illustrates an example in which the interaction calibration system calibrates receipt data associated with a user, according to some examples. The system accesses a first receipt 308, which was scanned and uploaded by the user using a mobile device after making a purchase at a grocery store. This type of receipt may have been captured using the user's phone camera or through a dedicated receipt scanning feature within a mobile application.

In addition, the system also accesses a second receipt 310, which was obtained directly from the point-of-sale (POS) system of the grocery store. This POS-sourced receipt is transmitted electronically, either via integration with the retailer's transaction processing system or through a third-party aggregator that collects structured transaction records in real time.

By accessing both types of receipts-user-captured and system-generated-the interaction calibration system is able to consolidate and cross-reference consumer interactions from multiple sources. This allows the system to detect gaps in coverage, validate receipt accuracy, and generate a more complete picture of product or service engagement by the user.

In some implementations, the interaction calibration system may apply a configurable time window filter when comparing interaction records and transaction log data. This filter ensures that only transactions and interaction events falling within a defined temporal range are considered candidates for calibration and discrepancy detection. For example, the system may compare receipts and transaction records that occurred within a ±3-day window, or may align events to a rolling 7-day period depending on the dataset resolution.

Applying a time window constraint helps prevent false matches between unrelated data points and improves the specificity of discrepancy detection. Without such filtering, the system may incorrectly assume a missing interaction when the relevant receipt actually exists just outside the comparison window. Temporal alignment also accounts for known delays in receipt scanning, posting lags in transaction logs, or asynchronous system updates across platforms.

The window duration may be statically defined or dynamically adjusted based on data quality, merchant type, or observed behavioral norms. For example, high-frequency merchants (e.g., grocery or QSR) may use narrower windows, while longer-tail categories (e.g., furniture or travel) may require broader matching intervals. In some cases, overlapping sliding windows may be used to improve recall and ensure robustness in matching logic.

At block 204, the interaction calibration system accesses transaction log data for the first user. The transaction log data can include transactions made by the first user using a transaction instrument.

The transaction log data may represent detailed records of transactions completed by the user using one or more transaction instruments, such as credit cards, debit cards, or other electronic payment mechanisms. In some cases, this transaction log data is retrieved from financial data sources, including direct consumer-authorized integrations with banks, credit card providers, or third-party financial aggregators.

The transaction log data can be received in a structured format, such as JSON, XML, or tabular data files, and may include metadata for each transaction, such as transaction timestamps, merchant names or identifiers, transaction amounts, payment method, merchant category codes (MCC), and geolocation information where available.

Unlike receipt data, which may provide item-level detail, transaction log data offers a complementary view focused on high-fidelity financial summaries. For example, the data might show that the user visited “Store ABC” on March 15 and spent $75.32 using a Visa card, but may not indicate which specific products were purchased. However, because this data is drawn from secure and trusted sources (such as card networks or financial institutions), this data is often more complete and unbiased, particularly when compared to receipt data that relies on user scanning, email scraping, or manual entry. As such, transaction log data can serve as a ground truth benchmark to validate, enhance, or project insights derived from receipt-level records.

The system ensures integrity and traceability by linking transaction log data to the appropriate user identity, such as via hashed user IDs, linked account tokens, anonymized device identifiers, or other secure associations. Furthermore, the transaction log data may include online and offline purchase events, enabling comprehensive calibration across both e-commerce and brick-and-mortar activity. The inclusion of multiple payment channels and merchant types—ranging from grocery stores and gas stations to restaurants and C-stores—helps the system detect gaps in receipt coverage and determine more accurate projection factors for a given user, region, or product category.

FIG. 3 illustrates a scenario where the system accesses data associated with a credit card 328 and corresponding transaction log data 302 of a particular user. The transaction log data 302 includes records of monetary transactions made by the user using a transaction instrument—such as a credit card—across various merchants and store locations. For example, the transaction log data indicates that the user has made a purchase at the grocery store eight times, the same grocery store where we have the receipts 308 and 310.

At block 206, the interaction calibration system identifies a discrepancy between a number of interactions by the first user in the electronic interaction data and a number of transactions in the transaction log data. The system detects instances where the available interaction data may underrepresent the user's actual activity, thereby enabling the system to calibrate and correct for incomplete or missing data.

The electronic interaction data—such as scanned receipts, email-based e-receipts, or in-app purchase records—may capture only a subset of the user's total interactions with products or services, due to factors such as lost receipts, unscanned purchases, limitations in data ingestion pipelines, or the user not opting into all available data sources. In contrast, the transaction log data—derived from financial records such as credit card or debit card histories—tends to provide a more comprehensive overview of user activity, as it includes all recorded monetary transactions regardless of whether a receipt was captured.

To determine the discrepancy, the system compares metrics such as the count of distinct store visits, total number of purchases, or frequency of transactions across both datasets. For example, the interaction data may show only two grocery receipts for a particular user over a month, while the transaction log reveals that the same user made eight separate payments at grocery stores during that period. This disparity indicates that six interactions are missing from the interaction dataset. The discrepancy may also be identified at different levels of granularity—for instance, by merchant, category, location, time period, or even product type—allowing the system to pinpoint where and how much interaction data is missing. This comparison process may involve time-series alignment, merchant name standardization, and transaction deduplication to ensure accurate matching across datasets.

In FIG. 3, the transaction log data shows a consistent pattern of purchases made by the user at a particular store. However, when the system compares this transaction log data to the user's electronic interaction data—such as receipt records captured from mobile scanning apps, loyalty emails, or digital purchase logs—the system identifies a discrepancy. Specifically, while the transaction log confirms that the user made a total of eight visits or purchases at the store, the interaction data only includes receipt records for two of those visits. This means that six instances of interaction are missing from the receipt dataset.

In some cases, the system identifies a discrepancy by a count-based comparison between electronic interaction data (such as receipts) and transaction log data (such as credit card records). The system tallies a number of recorded interaction events for a specific user over a given time period with a particular entity and compares that number to the number of transactions recorded in the transaction logs. For instance, if a user has two receipts for a grocery store in a month but the credit card data shows eight distinct transactions at the same store, the system flags a discrepancy of six missing receipt events.

In some cases, the system examines the time intervals between recorded receipts and compares them with timestamps in the transaction log. If there are extended periods with credit card activity but no corresponding receipt data, this may suggest missing interactions. For example, if a user submits a receipt for January 1 and January 15, but the credit card data shows transactions on January 3, 6, and 10 at the same store, the system detects likely unreported receipts during that timeframe.

In some cases, the system compares the set of merchants present in the interaction data to those in the transaction logs. If a merchant appears frequently in the transaction log but is absent or underrepresented in the receipt data, the system identifies a potential reporting gap.

For example, if Target appears ten times in the credit card records but only once in the receipt logs, the system identifies Target as a discrepancy source.

The system can evaluate the total or average monetary value of purchases in each dataset. If the total spend at a particular merchant is significantly higher in the credit card data than in the receipt data, the system infers that some purchases have not been reported via receipts. For example, if receipt data shows $250 of purchases at a merchant but credit card logs show $700, the discrepancy of $350 highlights likely missing receipts.

Beyond merchant-level spend, the system can segment transactions into categories such as groceries, fuel, dining, and apparel. A mismatch in category-specific totals between receipt and transaction data may indicate underreporting within certain segments. For instance, the absence of dining receipts despite frequent restaurant charges in the credit card logs could highlight gaps in food-related interaction tracking.

The system can compare temporal patterns between the two datasets. For example, if credit card transactions commonly occur on Saturday evenings but receipt submissions are limited to weekdays, the system identifies that weekend interactions are being underreported.

This type of discrepancy helps isolate behavioral trends that correlate with missing data.

At block 108, the interaction calibration system determines a projection factor for the first user based on the identified discrepancy. By detecting the discrepancy, the system can infer that the user's interaction data underrepresents their true behavior at that store. This insight becomes the basis for calculating a projection factor to adjust the receipt data accordingly.

For instance, the system may apply a multiplier to estimate what the user likely purchased during the six undocumented visits, based on patterns observed in their existing receipts or in broader consumer behavior trends. The information from the credit card 328 and transaction log data 302 not only helps uncover missing purchase events but also allows the system to perform more accurate calibrations of interaction data, ensuring more reliable metrics for downstream use cases such as sales forecasting, market penetration analysis, or retail performance evaluation.

By quantifying the discrepancy, the system not only detects missing data but also infers possible biases within the interaction data—such as underreporting at particular store types (e.g., convenience stores), by certain demographic groups, or during specific time windows (e.g., late-night purchases). The identification of these discrepancies lays the groundwork for the next stage of the process of determining a projection factor (as further described herein).

This projection factor serves as a multiplier or scaling value that compensates for underreported or missing data in the interaction dataset. The system evaluates how much of the user's activity is represented in the receipt-based interaction data (such as scanned or app-reported receipts) versus how much activity actually occurred, as evidenced by the transaction log data (such as credit card purchases or bank transaction history).

In some cases, the system determines a projection factor by identifying a ratio between the number of credit card transactions and the number of corresponding receipts available for the same user. For example, if the credit card log shows ten store visits, but only four receipts are available, the projection factor is calculated as 10/4=2.5. This projection factor reflects the multiplier needed to estimate the user's total interactions based on partial receipt data.

In some cases, the system determines a project factor by a time distribution. If missing receipts are clustered within a specific week or time window, the system applies time-weighted multipliers that correct for seasonal or temporal biases. For instance, shopping activity during holidays may show underreporting, prompting a higher weight for missing receipts from that period.

In some cases, analyzes the transaction log data for the first user to determine the frequency and timing of their transactions over a given time window, such as days, weeks, or months. These logs, derived from reliable sources such as credit card providers or bank-linked transaction platforms, serve as a more complete and trusted baseline of user activity.

The system constructs a temporal profile of transactions, identifying clusters of activity—such as increased visits during weekends, holidays, or promotional events—and then compares this temporal pattern to the distribution of interactions recorded in the electronic interaction dataset (e.g., scanned receipts or email-based receipts).

When the system detects that interaction data is missing disproportionately from specific time windows, such as the week of Thanksgiving or a known promotional period like Black Friday, it applies time-weighted projection factors. These factors are not uniform across the user's entire shopping history but vary based on the degree of discrepancy within each time slice. For example, if the transaction log shows six purchases made during the week of Christmas but the interaction data includes only one receipt during that period, the system calculates a localized projection factor of 6.0 for that week, rather than applying an overall factor that averages activity across all months. This ensures that short-term behavioral spikes are not muted or misrepresented in the calibrated dataset.

Moreover, the system may incorporate historical trend modeling to assess whether missing data during specific time windows represents an anomaly or aligns with consistent seasonal behavior. By referencing broader market-level benchmarks—such as known high-activity periods from other users or overall sales spikes reported in aggregate transaction data—the system further refines the projection factor for those windows. These dynamic adjustments allow for a more accurate reflection of true user behavior, especially in cases where temporal variations play a key role in purchasing patterns. As a result, downstream analyses such as seasonal demand forecasting, product launch impact measurement, or promotional effectiveness studies benefit from more granular and temporally aligned data calibration.

In some cases, the system determines a project factor based on the product category involved in the receipts. If food-related receipts are disproportionately missing while entertainment-related receipts are overrepresented, category-specific factors can be used to adjust the calibration per product segment.

In some cases, the system determines a project factor grouped by merchant, and a separate projection factor is determined per merchant. For example, a user may consistently underreport receipts from Store A but provide complete data for Store B. The system applies a projection factor that reflects the discrepancy rate for each merchant independently.

In some cases, the system determines a project factor using demographic metadata (e.g., age, income, region), where the system infers likely reporting behavior from similar users in the same segment. If older users are more diligent in scanning receipts than younger ones, the model adjusts the projection factor based on user profile characteristics.

In some cases, the system determines a project factor using geofencing or location data that indicates frequent store visits not reflected in receipt logs. The system adjusts the projection factor accordingly. For example, if a user's mobile device is seen visiting a grocery store six times, but only one receipt is captured, a higher projection factor is calculated to compensate.

In some cases, the system determines a project factor using a receipt-type bias adjustment. Some receipt types (e.g., email receipts vs. physical scans) may be more likely to be captured. The system weights projection factors based on receipt format availability. If email-based receipts are consistently captured but POS-scanned receipts are not, the projection factor increases for the latter.

The type of receipt a user provides—whether digital, physical, or derived from third-party platforms—can influence the accuracy and completeness of interaction data. For example, email receipts can be structured and high-quality, especially when sent directly from merchants like Amazon or Target. However, not all purchases generate email receipts, particularly for cash transactions or smaller purchases, which may cause underreporting. In such cases, the system may assign a moderate projection factor to adjust for these expected gaps.

In contrast, scanned paper receipts, where users manually upload or photograph physical receipts, introduce more variability. These are often incomplete due to human error, poor image quality, or simply forgetting to scan. As a result, the system applies a higher projection factor when transaction logs indicate more purchases than scanned receipts suggest.

On the other hand, POS-integrated app receipts, such as those linked to loyalty accounts, can be viewed as reliable when the user actively uses the app or card. If a discrepancy is detected between loyalty data and credit card records—such as unrecorded purchases when a loyalty card wasn't used—the system can apply retailer-specific correction factors to ensure coverage.

Other receipt formats such as text message receipts (e.g., from rideshare apps or coffee shops) often lack detailed itemization. These may either be excluded from analysis or given a lower confidence weight, supplemented by projection factors derived from more robust credit card data. Similarly, eCommerce platforms provide itemized digital receipts that are typically complete, but they may miss offline behavior. If the user's credit card log indicates significant in-person shopping, the system adjusts projection factors to compensate for this channel-based coverage gap.

When users submit OCR-parsed receipts (photos converted to structured data), the system evaluates the quality of OCR extraction. If the confidence score is low—due to misread items, unreadable text, or missing metadata—the system inflates the projection factor accordingly. In another case, loyalty card-only receipts are highly accurate for in-store purchases where the card is used, but if transaction logs reveal that the same user frequently shops without using the card, the system applies a selective correction to fill those gaps.

For subscription-based receipts, such as meal kits or digital services, the system recognizes the regularity of these transactions and may assign a neutral projection factor (e.g., 1.0) unless interruptions or anomalies are detected. The system also treats cash-based purchases as a significant source of underreporting. These are often not linked to any digital record unless manually scanned, so the system uses retailer-specific or demographic-based correction factors to estimate what is likely missing based on historical patterns.

In some cases, the system determines a project factor based on bank data normalization. If transaction log data includes bank-level summaries (e.g., monthly statements), the system calibrates based on total merchant spend. For example, if bank logs show $500 in grocery purchases and receipts only account for $200, the projection factor is determined as 500/200=2.5.

In some cases, the system determines a project factor using item-level prices from receipts. The system estimates whether the total reported expenditure matches the expected spend based on credit card logs. Discrepancies in total spend lead to recalculated projection factors, such as for users who underreport low-cost purchases.

In some cases, the system determines a project factor that analyzes recurring product purchases to establish expectations. If a user regularly buys milk weekly but misses reporting it for three weeks, the projection factor assumes those purchases occurred and increases accordingly using loyalty app integration. If users link retailer loyalty accounts, the system may receive partial purchase logs through those programs. Projection factors adjust based on comparisons between loyalty account records and scanned receipts.

In some cases, the system determines a project factor by integrating publicly available retail sales benchmarks (e.g., from SEC filings or industry reports) to compare expected vs. reported data. If a store reports $1M in regional sales but the receipt dataset captures only $100K, projection factors for users in that region increase proportionally.

In some cases, the system determines a project factor based on geography. For example, rural consumers may report more physical receipts than urban consumers who use mobile apps. If urban users show higher discrepancies, projection factors are scaled to reflect population density and reporting patterns.

In some cases, the system determines a project factor based on device behavior-based adjustments. If a user typically scans receipts using a mobile app but switches to email receipts, the system may temporarily reduce the projection factor to reflect higher completeness. Device usage analytics help the system understand likelihood of missing data by method.

In some cases, the system evaluates a certain time period (e.g., multi-month trends), and the system smooths out short-term variability. If a user is consistently underreporting by 50% over six months, the projection factor stabilizes around 2.0, even if short-term behavior varies widely.

At block 210, the interaction calibration system generates a calibrated electronic interaction dataset by applying the projection factor to the electronic interaction data. The result is a calibrated interaction dataset that can be used in downstream analysis with a higher degree of accuracy, reducing the risk of biased conclusions about user behavior, product affinity, or purchase patterns.

The calibrated electronic interaction dataset corrects for discrepancies identified between observed consumer interactions (e.g., from receipts) and actual activity inferred from transaction logs (e.g., credit card histories). By scaling the interaction data with the appropriate projection factor—tailored to each user, time window, store, or receipt type—the system produces an adjusted dataset that more accurately reflects the user's true purchasing behavior.

For example, if a user submitted three grocery receipts but their transaction log shows eight store visits, the system may apply a projection factor of 2.67 to account for underreported visits and corresponding product interactions. As such, calibrated receipts 212, 214, 216, 218, 220, 222 are generated.

This calibrated dataset can then be used in downstream applications with greater statistical confidence. Whether the goal is to analyze brand penetration, user loyalty, category share, product switching behavior, or regional purchasing trends, the calibration ensures the insights are not skewed by data incompleteness or demographic sampling biases.

By accounting for missing interactions, the system helps eliminate false negatives (e.g., assuming a user did not engage with a product when they actually did) and reduces overreliance on partial data sources. This enables marketers, retailers, and data analysts to make smarter decisions—such as reallocating ad budgets, refining audience targeting, or adjusting inventory planning—based on a more faithful view of consumer behavior. The result is a measurement model that reflects real-world outcomes more closely than traditional, uncalibrated datasets.

In FIG. 3, the system illustrates how a projection factor 324 can be determined and subsequently applied to generate an interaction calibration 326. The process begins with the interaction calibration system receiving two types of data: electronic interaction data (such as itemized receipts that reflect product-level purchase interactions) and transaction log data (such as credit card histories that reflect all payment events, even if receipts are missing). The system compares these datasets to detect discrepancies in the frequency, timing, or volume of observed interactions.

For example, FIG. 3 shows a user whose electronic interaction data includes only two grocery store receipts during a given month, while the corresponding credit card transaction log shows that the user made eight purchases at that same store during the same period. From this discrepancy, the system calculates a projection factor 324, which in this case would be approximately 4 (8 logged transactions÷2 receipts submitted). This factor reflects the estimated ratio of real-world purchase activity to observed interactions, correcting for underreporting or gaps in data coverage.

Once the projection factor 324 is established, the system applies it to the original interaction data to upscale or calibrate it accordingly. This results in a calibrated interaction dataset 326, which represents an adjusted version of the user's actual behavior.

For instance, if the original receipt data indicated two purchases of cereal, applying a projection factor of 4 would estimate approximately 8 (rounded as needed) cereal interactions for the same timeframe. This calibrated dataset 326 is more representative of the user's full activity and can then be used in downstream analytics—such as estimating product penetration, purchase frequency, or loyalty—leading to more accurate and less biased business insights.

In some cases, the system determines discrepancies and projection factors by aggregating data from multiple credit card accounts associated with a single user. This approach ensures a more complete picture of the user's transaction history, particularly when the user pays with different credit cards across separate visits to the same merchant. For example, a consumer might pay with a personal credit card during one grocery trip and use a corporate card on another occasion. By consolidating transaction log data from all known accounts linked to the user—through user IDs, hashed emails, or device metadata—the system can more accurately assess the true number of visits or purchases and identify any gaps in the electronic interaction data.

In some cases, the system performs its calibration analysis at different levels of aggregation, such as at the individual user level, household level, or across broader geographies. For instance, multiple users residing in the same household may contribute to shared grocery shopping activity. By grouping users at the household level—based on shared addresses, devices, or payment methods—the system can detect if certain family members' receipts are missing and apply a unified projection factor accordingly. Similarly, at the geographic level, such as by ZIP code or DMA (Designated Market Area), the system can identify underreported regions where receipt data is scarce but credit card or bank-level transactions suggest higher purchase activity.

The system can also apply a top-down calibration approach, where it first analyzes retail-level revenue data (e.g., $2M in quarterly revenue reported by a grocery chain), then distributes projection logic downward by geography and finally to individual households. This allows the system to reconcile aggregated sales reports with known transaction records from credit card data, adjusting receipt-based datasets to more accurately reflect expected sales patterns at each hierarchical level (as further described herein).

In addition to reconciling data across payment instruments and user hierarchies, the system accounts for multi-source receipt discrepancies. For example, electronic interaction data might be gathered via email scraping (e.g., scanning digital receipts from Gmail or Outlook), app-based manual uploads, or OCR scans of printed paper receipts. If the email module detects five receipts from a user in a given timeframe but the OCR scan module shows zero, the system identifies a discrepancy between submission modalities. This could reflect user behavior (e.g., forgetting to scan physical receipts) or technical issues (e.g., poor OCR recognition).

In some embodiments, the system accesses transaction log data from multiple independent sources, such as a first transaction log database and a second transaction log database, each external to the one or more hardware processors executing the method. These databases may originate from distinct financial institutions, payment processors, banks, or consumer applications—each with their own proprietary schemas, data structures, or API formats. For example, the first transaction log database may store data using JSON objects with nested merchant metadata and timestamp formatting, while the second may use flat CSV-style records with differently named fields or abbreviated codes for merchants and categories.

To ensure data compatibility and seamless downstream processing, the system normalizes the first and second subsets of the transaction log data. This includes reconciling field names, standardizing date formats, mapping merchant categories to a shared taxonomy, unifying currency symbols, aligning time zones, and harmonizing product codes when available. The normalization step enables the system to analyze the transaction log data as a single coherent dataset, regardless of the original data format or source origin.

In some cases, the first transaction log system associated with the first subset of transaction data operates independently from the second transaction log system associated with the second subset. These systems may belong to different data providers, retail partners, or financial institutions, and are not required to communicate directly with one another. Rather, the calibration system acts as a centralized processing unit that aggregates, interprets, and unifies transaction data from these disparate sources. This architecture allows the system to overcome the fragmentation common in transaction data ecosystems and generate a comprehensive view of consumer behavior across multiple financial platforms or data pipelines.

In some implementations, the interaction calibration system may generate projection factors not only at the individual user level, but also across broader segments or cohorts. These segments may be defined based on shared attributes such as merchant identifier, product category, geographic region, user demographic, or engagement frequency. By aggregating users with similar interaction and transaction behavior, the system can compute representative projection factors for the group, which are then applied to users with limited or missing data.

Segment-level projection factors are particularly useful in scenarios where user-level data is sparse, noisy, or unavailable due to privacy constraints. For example, when a user does not provide sufficient interaction history to compute a reliable individual correction, the system may instead assign a projection factor derived from others in the same merchant or regional cohort. This cohort-based approach ensures broader coverage and maintains calibration quality even in low-data environments.

The system may determine the optimal granularity dynamically by analyzing data availability and historical calibration performance. In some implementations, segment-level factors may be weighted or blended with user-specific factors when partial data is available.

This hybrid method helps strike a balance between personalized adjustment and statistical reliability, improving the overall robustness of the calibrated dataset.

### MODEL FOR ONE OR MORE PROCESSES

In some cases, the interaction calibration system performs calibration using one or more calibration models, such as a machine learning model, to generate a projection factor or adjusted dataset. The calibration may be based on detected discrepancies between structured datasets, such as electronic interaction data and transaction log data.

The system establishes a computational connection between different sources of user activity data—such as receipts and credit card logs—by leveraging structured data correlation techniques. Rather than relying on assumptions or user-submitted records alone, the system uses programmatic modeling to estimate and correct for gaps, ensuring that downstream metrics are derived from calibrated and harmonized datasets.

One of the key technical challenges in calibrating interaction data is that datasets often originate from separate, independent systems that may not directly communicate or share common identifiers. For example, receipt data from scanned emails, OCR uploads, or in-app submissions may be incomplete, whereas transaction log data from credit cards or bank accounts may provide a more complete financial history without granular item-level details.

These datasets often differ in format, schema, and completeness, making calibration a nontrivial computational task.

To accurately identify discrepancies and derive a calibrated dataset, the system performs normalization, discrepancy detection, and statistical modeling. The system provides technical solutions to challenges associated with integrating data across multiple, disjoint systems—including non-communicating databases, missing or malformed data, and user privacy-preserving identifiers.

The interaction data may include detailed item-level purchases, store identifiers, merchant information, timestamps, and product categories. The transaction log data may include merchant names, transaction amounts, transaction times, and payment instrument metadata. However, these datasets typically use different field names and data encodings. For instance:
Interaction Data: {“items”: [“Bread”, “Milk”], “timestamp”: “2025-04-01T15:12:00Z”, “merchant”: “SuperMart A”}
Transaction Log Data: {“amount”: 11.75, “datetime”: “2025-04-01 15:10”, “location”: “SUPERMART-LOC874”, “instrument”: “Visa-1234”}

The system harmonizes timestamp formats, merchant aliases, and standardizes product and location mappings to align the datasets. Once normalized, the system identifies discrepancies—e.g., where transaction logs show multiple merchant visits but receipt logs do not reflect matching purchase events.

The system may then apply one or more calibration models. These models may include rule-based logic, machine learning classifiers, statistical discrepancy detection, or hybrid approaches. For example, if the transaction logs show five visits to Store A but only one corresponding receipt is recorded, the system can calculate a projection factor of 5× for the unobserved receipt events. This projection factor may be further adjusted using weighting schemes that account for factors such as user segment, geography, receipt type, or day of week.

In some cases, statistical methods such as Monte Carlo simulations or negative binomial distributions may be used to model the expected number of missing events. The system may also use AI models trained on historical receipt completeness data to estimate user-specific correction factors. These models can account for behaviors such as receipt scanning compliance, device usage patterns, and merchant-specific reporting rates.

The system applies the resulting projection factor to the original interaction data to produce a calibrated interaction dataset. This calibrated dataset more accurately reflects the user's actual shopping behavior and can be used for more reliable downstream analytics, such as brand penetration, basket size, product affinity, or time-series forecasting. By grounding the calibration process in structured data modeling rather than heuristics or guesswork, the system provides a technical solution to the longstanding problem of underreported or fragmented consumer interaction data.

In some implementations, the calibration model may include probabilistic scoring, where each potential discrepancy is evaluated using confidence levels or likelihood scores based on observed historical behaviors. For instance, if a user regularly shops at a particular store every Saturday, but receipts are missing on one weekend, the system can infer with high confidence that the visit occurred and apply a calibrated entry for that gap.

By allowing for calibration across multiple data dimensions—such as user ID, household ID, merchant ID, geographic region, receipt type, or payment method—the system can perform multi-resolution calibration. This enables projection not just at the individual level, but also at aggregate levels for market research, brand performance estimation, or regional trend forecasting.

Thus, the calibration module enables advanced attribution and data correction functionality by applying structured normalization, cross-source harmonization, and machine learning-based projection modeling to resolve discrepancies and fill in missing data with high confidence.

### MACHINE LEARNING CALIBRATION MODULE

The interaction calibration system may leverage one or more machine learning models to analyze, compare, and calibrate disparate datasets that record consumer behavior across multiple data channels. Because electronic interaction data (e.g., receipts) and transaction log data (e.g., credit card usage records) are collected independently and often lack a shared identifier, traditional rule-based models struggle to account for discrepancies, missing events, and reporting bias.

These issues limit the reliability of behavioral insights derived from raw data. To address these challenges, the system uses a trained machine learning model to detect gaps, assess likelihood of unreported activity, and dynamically generate correction weights (i.e., projection factors) that can be applied to interaction data.

The system's machine learning model may be trained on large-scale historical datasets that include known cases of partial interaction coverage and full transaction visibility. By analyzing such patterns, the model learns typical user behaviors—for instance, visit frequency, purchase cadence, and retailer preferences—and can then detect anomalies or deviations when interaction data is incomplete. If the model observes that a user typically visits a grocery store 10 times per month based on transaction log data but only has 3 receipt records, it can infer that 70% of interactions are unreported. It can then generate a corresponding projection factor for that user, specific store, or product category. This dynamic weighting allows the system to calibrate the dataset with higher precision than static mathematical assumptions.

In some cases, the machine learning model also evaluates contextual and behavioral variables to estimate the source and scope of underreporting. These variables may include receipt submission modality (e.g., photo scan vs. email receipt), payment instrument type (e.g., debit card, credit card, loyalty account), retailer-specific behavior patterns (e.g., likelihood of providing printed vs. digital receipts), or demographic indicators (e.g., reporting bias by age, income, or geography). The model incorporates these factors to generate nuanced correction values at the individual, household, regional, or merchant level. For example, if certain retailers or geographic regions show a higher discrepancy rate in user-submitted receipt data, the model may apply a higher projection factor for interactions associated with those contexts.

Beyond discrepancy detection and projection factor determination, the machine learning model can also support downstream calibration. Specifically, the system can use the model to generate a calibrated electronic interaction dataset by selectively amplifying or discounting certain entries based on confidence scores, behavioral modeling, or historic reporting accuracy. For example, if the model predicts with high certainty that a user's receipt history is underreported for a specific brand, the system can increase the weight of those brand level interactions in the final dataset. Conversely, if a particular user consistently submits comprehensive receipts but only for specific merchants, the model may avoid over-projecting those entries. By continuously learning from new data, the system maintains up-to-date calibration logic that evolves with changing user behaviors, submission trends, and payment technologies.

Overall, the machine learning calibration module plays a vital role in ensuring that data integrity and reporting coverage are maximized, enabling more accurate consumer analytics, market penetration analysis, and product performance evaluation. Rather than relying on broad assumptions or heuristic projections, the system applies data-driven modeling techniques that scale with diverse data sources, support real-time calibration, and minimize bias across users, retailers, and channels.

In some implementations, the interaction calibration system may include a feedback loop that enables the machine learning model to be periodically retrained based on downstream outcomes. For example, when calibrated interaction data is used to drive advertising campaigns, the system may monitor post-campaign performance metrics such as conversion rate, return on ad spend, or engagement levels. These outcomes can be used to evaluate the effectiveness of the projection factors originally applied during calibration. Over time, the system may retrain or fine-tune the model using this feedback, allowing it to adapt to evolving consumer behavior and improve calibration accuracy.

### Actionable Insights Based on Calibrated Interaction Data

After the interaction calibration system has successfully generated a calibrated interaction dataset, the system analyzes the calibrated dataset to produce actionable insights that improve advertising targeting, audience segmentation, and campaign effectiveness. Because the calibrated data more accurately reflects true consumer behavior—corrected for underreporting or missing receipt submissions—it enables more reliable conclusions about product affinity, repeat behavior, market penetration, and brand performance. These insights allow advertisers, marketers, and brands to direct efforts and budget toward more receptive consumer segments and underpenetrated markets with greater confidence.

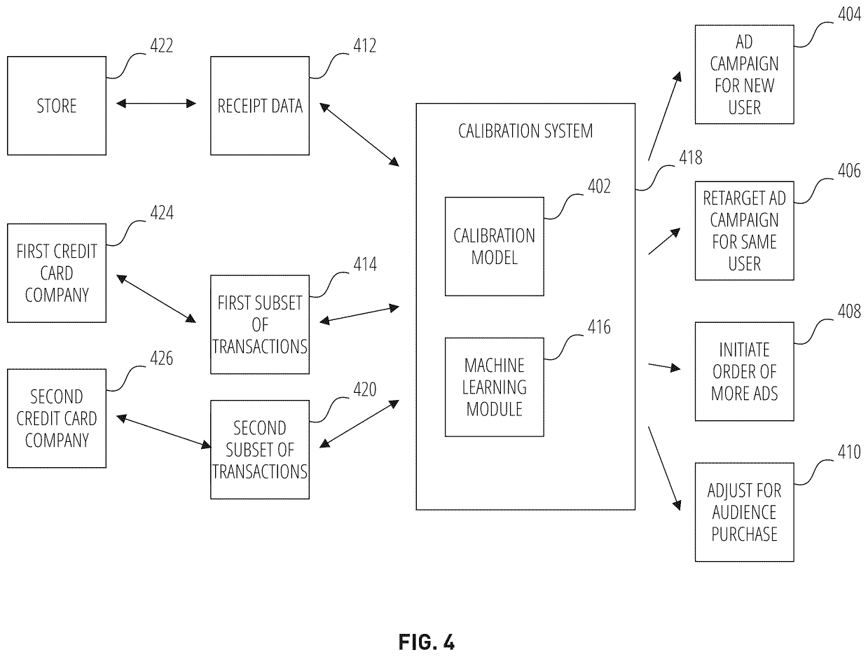

FIG. 4 illustrates how the interaction calibration system applies projection factors to raw receipt data and transaction log data to generate a more accurate view of consumer-product interactions. For instance, when electronic receipt data 308 and 310 are incomplete—due to receipt loss, non-participation in scanning programs, or merchant type limitations—the system accesses transaction log data 302 from credit card or bank sources to determine that additional unrecorded product interactions occurred. Based on this discrepancy, the system calculates a projection factor 324 and applies it to the incomplete receipt data to create a calibrated interaction dataset 326. This dataset can be used to measure not only how often consumers are interacting with certain products but also to estimate broader metrics across user groups, such as geographic regions, household segments, or retailer-level behavior.

The calibrated dataset enables advertisers to more precisely identify opportunities for targeting or retargeting campaigns. For example, if a household appears to have only interacted with a product twice in a month based on receipts, but transaction logs reveal eight total shopping events, the system uses the projection factor to recalibrate this behavior. This allows the system to segment the household more accurately (e.g., as an occasional user vs. a loyal customer) and deliver tailored promotional content accordingly. Brands can then trigger targeted campaigns—such as mobile push notifications, in-store ads, or digital coupons—to engage with these consumers based on more realistic usage patterns rather than guesswork derived from incomplete data.

Moreover, retailers and advertisers can adjust distribution and pricing strategies across geographies where interaction data was previously underrepresented. For instance, if calibrated data reveals that a product is significantly underreported in a particular region due to receipt submission biases, the system can identify hidden demand and recommend increased ad spend or inventory in that area. Likewise, if a specific product category is showing inconsistent interaction patterns when compared against bank-level transaction volumes, the system may surface this insight for brand teams to reevaluate placement or bundling strategies.

By analyzing trends across calibrated datasets over time, the system can detect shifts in loyalty, product switching, or new consumer interest patterns. This enables predictive targeting, where the system not only reacts to past behaviors but forecasts future purchasing behavior based on statistically corrected, bias-adjusted consumer data. As a result, businesses can optimize campaigns, reduce wasted spend, and engage audiences with greater relevance.

FIG. 4 illustrates a system architecture that enables the calibration of electronic interaction data using multiple sources of transaction log data, and applies the resulting calibrated dataset to drive targeted advertising campaigns, retargeting strategies, and media placement decisions, according to some examples. The system addresses data gaps in receipt collection by incorporating transaction data from multiple financial providers, generating a projection factor to correct for missing interactions, and then leveraging this corrected dataset to inform advertising operations across digital and physical channels.

Store 422 represents a merchant or retailer location where users interact with products or services and receive some form of receipt (e.g., printed, emailed, or app-based). This store system may include a point-of-sale (POS) system, a smart checkout system, or digital kiosks capable of generating receipt data. These receipts reflect recorded interactions between the user and the retailer.

Receipt data 412 includes digital representations of those interactions—such as scanned receipts, structured e-receipts, OCR-parsed documents, or app-scraped confirmations of purchases. This data is routed to a calibration module 402 of the interaction calibration system 418, where it is treated as partial—but valuable—evidence of user activity. However, the system recognizes that receipt data alone may not fully reflect a user's total engagement with the store or product line.

To address the inherent incompleteness of receipt data, the system integrates external transaction log data from one or more financial data providers:
Credit Card Provider 1 (424) supplies a first subset of transaction log data 414.
Credit Card Provider 2 (426) provides a second subset of transaction log data 420.

Each of these transaction log subsets may originate from different institutions or payment networks (e.g., Visa, Mastercard, AmEx, or direct-from-bank systems), and may be in different formats. These subsets represent a broader, more reliable view of the user's transactions—regardless of whether a receipt was collected.

These subsets are also transmitted to the interaction calibration system 418, which merges and normalizes the data to identify discrepancies between interaction data and actual transaction logs. In doing so, the system ensures that no single source dominates the dataset and that transaction gaps due to missing receipts or modality failures (e.g., OCR errors or non-uploaded receipts) can be detected and corrected.

The Interaction Calibration system 418 receives receipt data and multiple streams of transaction log data, performs discrepancy analysis, and determines projection factors to account for underreporting or data sparsity in the electronic interaction dataset.

This subsystem includes a machine learning module 416, which performs several key functions:

Identifies patterns of underreporting by comparing actual visit or transaction frequency (from credit card logs) against known receipts.

Trains on historical data to estimate missing interactions using behavioral, temporal, and geographic features.

Applies regression models, classifiers, or probability weighting to infer unrecorded purchase behavior.

Dynamically updates projection factors based on evolving user behavior or seasonal effects.

After the projection factor is determined, the system applies it to the interaction dataset to generate a calibrated interaction dataset—which more accurately reflects the user's true activity history with merchants and product categories.

Once the calibrated dataset is created, it is used to optimize and enhance advertising strategies, represented by the boxes at the bottom of FIG. 4. The system can start an ad campaign for a new user 304. Using the corrected interaction history, the system can launch targeted ad campaigns for users who had limited or no prior exposure in the uncalibrated data. For instance, if a user appeared to only visit a store once (based on receipts) but transaction logs reveal frequent visits, the system can now qualify them as a potential high-value target for new product or brand outreach.

In some cases, the system can retarget a campaign for a same user 406. For users who engaged with a product but did not convert—or whose engagement was partially captured—the system can initiate a retargeting strategy. Now, with better insights into the user's actual engagement patterns, ads can be served through personalized channels (e.g., mobile, email, connected TV) to encourage follow-through or repeat purchases.

In some cases, the system can initiate more order of advertisements 408. If calibrated data reveals strong brand affinity or a high projection factor in a particular region or demographic, the system can trigger an automated workflow to order more ads, either in physical retail environments (e.g., in-store signage) or digital placements (e.g., programmatic media buys). This proactive ad ordering ensures that media budgets are allocated based on more accurate consumer activity data.

In some cases, the system can adjust a desired audience 410. The system can adjust targeting and frequency based on improved knowledge of purchase behavior. For instance, if certain products are underrepresented in raw data but prominent in the calibrated dataset, the system adjusts campaign priorities to reflect this hidden demand. It may increase frequency caps for users more likely to convert, or reassign ad budget away from users now identified as habitual non-converters.

Some retailers are known to generate fewer digital or physical receipts due to operational limitations (e.g., vending machines or fast food chains). The system maintains a knowledge base of retailers with low expected receipt capture rates and cross-checks this with user transaction history. If a user frequents these retailers but has no receipts to show for it, the system flags a probable discrepancy.

The system compares a user's reporting behavior to that of similar users in their demographic or geographic cohort. If most users in the same income bracket or zip code report an average of 10 receipts per 15 transactions, but a user only reports 3, the system highlights this anomaly as a discrepancy.

In cases where credit card data is associated with multiple individuals (e.g., family members sharing a card), the system compares the number of expected receipts based on past household behavior. If a household typically generates 12 receipts per month, and suddenly only 4 are received despite ongoing credit card activity, the system can identify this as a discrepancy.

The system uses regional norms to assess whether certain locations or DMAs (designated market areas) are underreporting. For example, in higher-income neighborhoods, users may be less likely to submit receipts under a certain dollar threshold. If credit card activity remains high but few receipts are available, the system flags this regional underreporting.

### TOP DOWN APPROACH

The top-down approach described here refers to a calibration process that begins with large-scale, externally reported sales data—such as SEC filings or publicly available financial disclosures from retailers—and progressively narrows the analysis down to more granular levels, such as regions (e.g., DMAs or zip codes) and households.

For example, the system can leverage data from SEC filings-public reports that major retailers are required to file (e.g., 10-K, 10-Q). These filings often include:
Total annual or quarterly revenues,
Store count,
Revenue per store or per region, or
Revenue from specific verticals (e.g., grocery, pharmacy, e-commerce).

For example, suppose a first merchant's SEC filing shows that a particular store generates $2 million in revenue per year. This sets a “truth” benchmark against which system-collected data (e.g., receipt data or credit card data) can be compared.

If the receipt data collected by the system for that same merchant's location only shows $250,000 in transactions, this indicates substantial underreporting. The system calculates a projection factor of 8 (i.e., $2M /$250K), which can then be used to scale up the observed data to more accurately represent the true activity level for that store.

The system can then refine the projection further using credit card data at a regional level, such as:
Zip code level
Designated Market Area (DMA) level

Suppose credit card data for the zip code where the merchant store is located shows $600,000 in total spend, while receipt data collected for that same zip code shows $350,000. This suggests that even at the zip code level, the receipt data is incomplete, yielding a regional projection factor of 800K/350K≈2.29.

This additional geographic calibration step helps differentiate between store-level underreporting and regional behavioral trends. Some stores may serve a broader or more mobile customer base, and shoppers may live in one zip code but shop in another. The system uses this geo-level comparison to adjust the distribution of spending more accurately, especially in high-traffic or cross-regional retail areas.

The system can apply projection logic at the household level by:
Mapping transaction log data (e.g., credit card entries) to individual users or households within a zip code,
Comparing the number of transactions per household in the transaction logs with the number of receipts the system has collected for that same household,
Estimating what portion of transactions are missing and determining a household-specific projection factor.

For example, if a household in the area has 10 credit card transactions at the merchant but only 3 receipts captured in the system, the projection factor for that household is about 3.33×. This allows for highly localized, individualized correction, improving accuracy for downstream segmentation or behavior prediction.

Together, these levels form a multi-resolution calibration framework:
The retail-level calibration ensures that the system's data aligns with officially reported sales figures.
The geographic-level calibration refines the projection based on spending behavior across different zip codes or DMAs.
The household-level calibration ensures that user-level behavior is properly reflected, especially in demographic modeling or targeted advertising.

By combining these layers, the interaction calibration system can produce a calibrated dataset that is both accurate at the macro level and detailed enough for precise micro-targeting and analytics.

### GEOFENCING

If the system has access to geofencing or store visit data (e.g., from mobile devices), the system can compare physical presence in a store with submitted receipts. If the system detects multiple store visits with no corresponding receipts or credit card entries, the system can determine this as underreporting or cash-based purchases that were not captured.

In some cases, the system may cross-reference this data with known retailer mappings, ZIP code level market zones, or store-specific location data to better understand regional consumer activity.

In some examples, the interaction calibration system enhances its ability to identify discrepancies and estimate projection factors by incorporating geofencing data that reveals how frequently a user visits a given store, even when no corresponding receipt data is available.

Geofencing data can be gathered using mobile device sensors (e.g., GPS, Wi-Fi, Bluetooth), enabling the system to determine when a user enters or exits predefined geographic zones associated with retail locations. This data is particularly valuable in cases where receipt data is incomplete due to consumer behavior (e.g., declining digital receipts, forgetting to scan), merchant limitations (e.g., lack of POS integration), or technical failures (e.g., OCR errors, email parsing failures).

For example, the system may detect through geofencing that a user visited a specific Walmart location on seven separate occasions in a given month. However, the system's electronic interaction data—such as scanned receipts, emailed receipts, or uploaded photos—only reflects three visits. This discrepancy suggests that the system is missing data for at least four visits. By comparing the number of confirmed store entries from geofencing logs with the number of recorded interactions, the system identifies a potential underreporting bias and initiates a projection factor calculation. In this case, a projection factor of approximately 2.33 (7/3) may be applied to estimate the user's total interaction volume more accurately.

While geofencing data alone does not confirm that a transaction took place, it serves as a strong behavioral signal that a user was likely shopping or engaging with the store. The interaction calibration system uses this inferred store presence to support the hypothesis that additional interactions may have occurred but were not captured by the system's receipt collection mechanisms. To avoid overestimation, the system may pair this geofencing data with transaction log data—such as credit card history—to further validate whether an economic exchange occurred during the visit. If transaction log data confirms a charge at the merchant corresponding to the geofencing event, the system boosts the confidence score of the projected interaction.

Moreover, the interaction calibration system may incorporate visit duration or visit frequency into its projection logic. If a user enters a store but leaves within two minutes, the system may discount the visit as low-purchase probability. Conversely, if the user spends 30 minutes in the store, the system weights the visit more heavily when estimating missing receipts. Over time, the system can refine these heuristics by analyzing large-scale behavior patterns across users to determine which visit durations and time-of-day windows are most predictive of genuine product interactions.

In addition to individual user calibration, geofencing data can be aggregated at a group or regional level. For instance, if a store in Zip Code 90210 receives an average of 1,000 monthly visits based on geofencing logs, but only 300 of those visits yield recorded receipts across all users, the system can estimate a regional projection factor of 3.33. This factor can be applied to receipt datasets from that zip code to scale up observed interactions to more closely reflect expected consumer activity, especially in under-instrumented or lower-reporting areas.

Because geofencing alone cannot confirm the contents of a transaction, the interaction calibration system treats geofencing as one component in a multi-modal calibration pipeline.

The system may cross-reference geofencing presence with credit card logs, loyalty app usage, or historical behavioral profiles to ensure that projected interactions are grounded in reasonable assumptions about consumer intent and behavior. Through this approach, the system ensures a more accurate and comprehensive calibration of interaction datasets, enabling more reliable downstream analysis for purchase behavior modeling, demographic segmentation, or targeted advertising.

FIG. 3 illustrates how geofencing data 304 can be used by the interaction calibration system to enhance the accuracy of receipt-based interaction datasets. Geofencing data 304 refers to location signals—such as GPS, Wi-Fi, or Bluetooth pings—collected from a user's mobile device 330, which indicate when and how often the user has entered the physical boundaries of a store or retail environment.

Unlike receipt data, which only reflects confirmed purchases or logged interactions, geofencing data provides a broader view of real-world consumer presence, capturing store visits that may not have resulted in receipt submissions. For example, if the geofencing data shows that a user entered a Walmart store eight times in a month, but the receipt data only includes three purchases, the system can infer that several transactions may be missing due to unsubmitted receipts or other gaps in collection. This discrepancy forms the basis for calculating a projection factor.

The interaction calibration system uses this geofencing-derived discrepancy to recalibrate the receipt data for that user or user segment. By applying a projection factor derived from the ratio of geofenced visits to recorded receipts (e.g., 8 visits/3 receipts=2.67), the system adjusts the weight or influence of the existing receipt data to better approximate the user's true engagement or purchasing behavior.

This recalibrated dataset enables more accurate downstream analysis, such as estimating market penetration, user-level purchasing frequency, or behavioral segmentation.

Furthermore, because geofencing data is passive and can capture non-purchasing visits as well, it helps the system reduce bias introduced by incomplete receipt reporting-particularly useful for low-frequency products, underreported store types, or demographics less likely to upload receipts consistently.

### MACHINE ARCHITECTURE

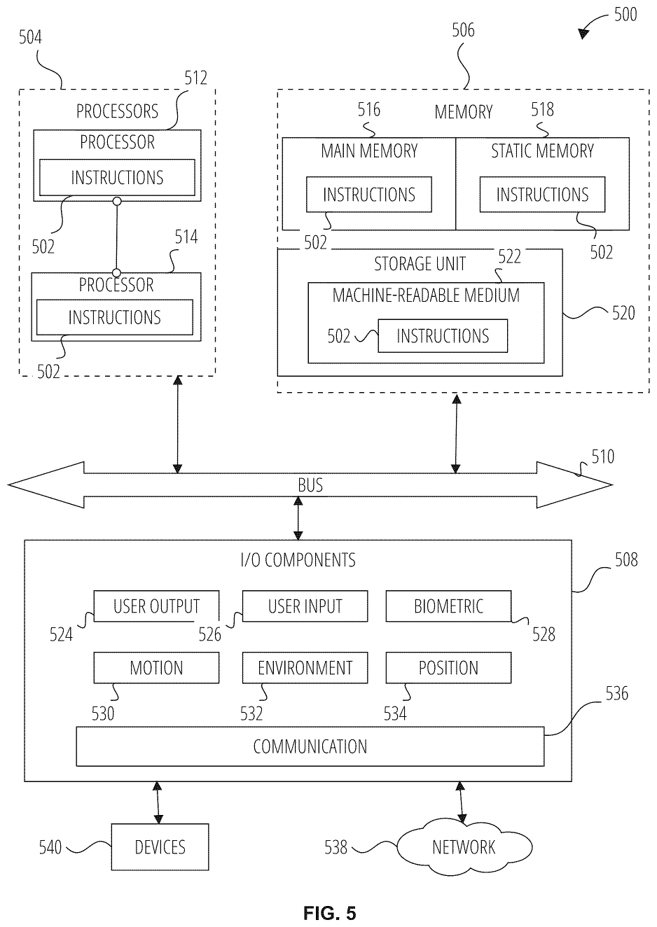

FIG. 5 is a diagrammatic representation of the machine 500 within which instructions 502 (e.g., software, a program, an application, an applet, an app, or other executable code) for causing the machine 500 to perform any one or more of the methodologies discussed herein may be executed. For example, the instructions 502 may cause the machine 500 to execute any one or more of the methods described herein. The instructions 502 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. The machine 500, for example, may comprise a user system or any one of multiple server devices forming part of the server system. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 508, which may be configured to communicate with each other via a bus 510. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 512 and a processor 514 that execute the instructions 502. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 516, a static memory 518, and a storage unit 520, both accessible to the processors 504 via the bus 510. The main memory 506, the static memory 518, and storage unit 520 store the instructions 502 embodying any one or more of the methodologies or functions described herein. The instructions 502 may also reside, completely or partially, within the main memory 516, within the static memory 518, within machine-readable medium 522 within the storage unit 520, within at least one of the processors 504 (e.g., within the processor's cache memory), or any suitable combination thereof, during execution thereof by the machine 500.

The I/O components 508 may include a wide variety of components to receive input, provide output, produce output, transmit information, exchange information, capture measurements, and so on. The specific I/O components 508 that are included in a particular machine will depend on the type of machine. For example, portable machines such as mobile phones may include a touch input device or other such input mechanisms, while a headless server machine will likely not include such a touch input device. It will be appreciated that the I/O components 508 may include many other components that are not shown in FIG. 5. In various examples, the I/O components 508 may include user output components 524 and user input components 526. The user output components 524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 508 may include medical device components 628, motion components 530, environmental components 532, or position components 534, among a wide array of other components. For example, the medical device components 628 include components to detect data from medical devices, as further described herein.

The motion components 530 include acceleration sensor components (e.g., accelerometer), gravitation sensor components, rotation sensor components (e.g., gyroscope).

The environmental components 532 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

The position components 534 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 508 further include communication components 536 operable to couple the machine 500 to a network 538 or devices 540 via respective coupling or connections. For example, the communication components 536 may include a network interface component or another suitable device to interface with the network 538. In further examples, the communication components 536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 may be another machine or any of a wide variety of peripheral devices (e.g., a peripheral device coupled via a USB).

Moreover, the communication components 536 may detect identifiers or include components operable to detect identifiers. For example, the communication components 536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 536, such as location via Internet Protocol (IP) geolocation, location via Wi-Fi® signal triangulation, location via detecting an NFC beacon signal that may indicate a particular location, and so forth.

The various memories (e.g., main memory 516, static memory 518, and memory of the processors 504) and storage unit 520 may store one or more sets of instructions and data structures (e.g., software) embodying or used by any one or more of the methodologies or functions described herein. These instructions (e.g., the instructions 502), when executed by processors 504, cause various operations to implement the disclosed examples.

The instructions 502 may be transmitted or received over the network 538, using a transmission medium, via a network interface device (e.g., a network interface component included in the communication components 536) and using any one of several well-known transfer protocols (e.g., hypertext transfer protocol (HTTP)). Similarly, the instructions 502 may be transmitted or received using a transmission medium via a coupling (e.g., a peer-to-peer coupling) to the devices 540.

### SOFTWARE ARCHITECTURE

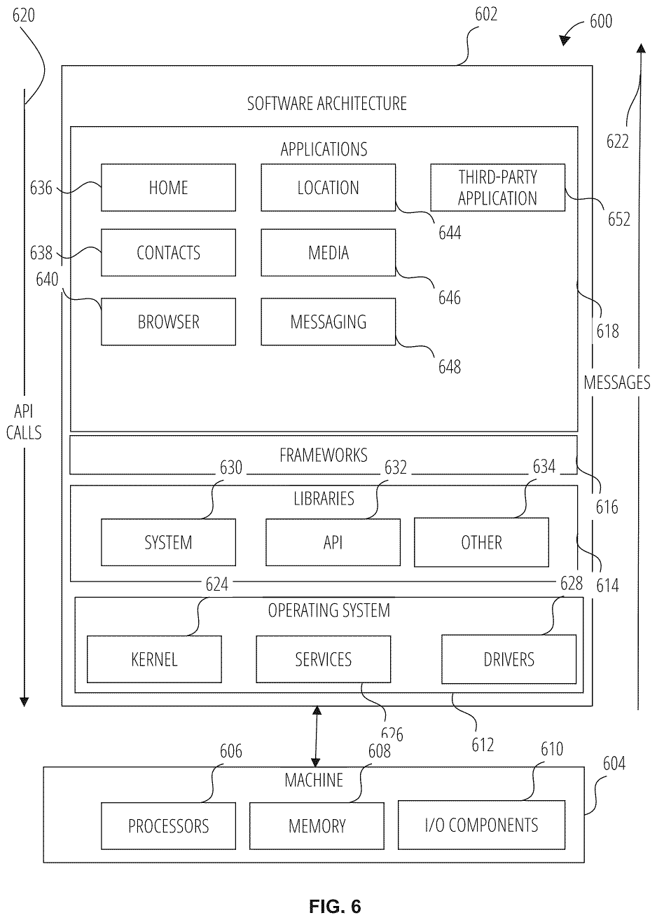

FIG. 6 is a block diagram 600 illustrating a software architecture 602, which can be installed on any one or more of the devices described herein. The software architecture 602 is supported by hardware such as a machine 604 that includes processors 606, memory 608, and I/O components 610. In this example, the software architecture 602 can be conceptualized as a stack of layers, where each layer provides a particular functionality. The software architecture 602 includes layers such as an operating system 612, libraries 614, frameworks 616, and applications 618. Operationally, the applications 618 invoke API calls 620 through the software stack and receive messages 622 in response to the API calls 620.

The operating system 612 manages hardware resources and provides common services. The operating system 612 includes, for example, a kernel 624, services 626, and drivers 628. The kernel 624 acts as an abstraction layer between the hardware and the other software layers. For example, the kernel 624 provides memory management, processor management (e.g., scheduling), component management, networking, and security settings, among other functionalities. The services 626 can provide other common services for the other software layers. The drivers 628 are responsible for controlling or interfacing with the underlying hardware. For instance, the drivers 628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 614 provide a common low-level infrastructure used by the applications 618. The libraries 614 can include system libraries 630 (e.g., C standard library) that provide functions such as memory allocation functions, string manipulation functions, mathematic functions, and the like. In addition, the libraries 614 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 614 can also include a wide variety of other libraries 634 to provide many other APIs to the applications 618.

The frameworks 616 provide a common high-level infrastructure that is used by the applications 618. For example, the frameworks 616 provide various graphical user interface (GUI) functions, high-level resource management, and high-level location services. The frameworks 616 can provide a broad spectrum of other APIs that can be used by the applications 618, some of which may be specific to a particular operating system or platform.

In an example, the applications 618 may include a home application 636, a contacts application 638, a browser application 640, a location application 644, a media application 646, a messaging application 648, and a broad assortment of other applications such as a third-party application 652. The applications 618 are programs that execute functions defined in the programs. Various programming languages can be employed to create one or more of the applications 618, structured in a variety of manners, such as object-oriented programming languages (e.g., Objective-C, Java, or C++) or procedural programming languages (e.g., C or assembly language). In a specific example, the third-party application 652 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 652 can invoke the API calls 620 provided by the operating system 612 to facilitate functionalities described herein.

### MACHINE-LEARNING PIPELINE

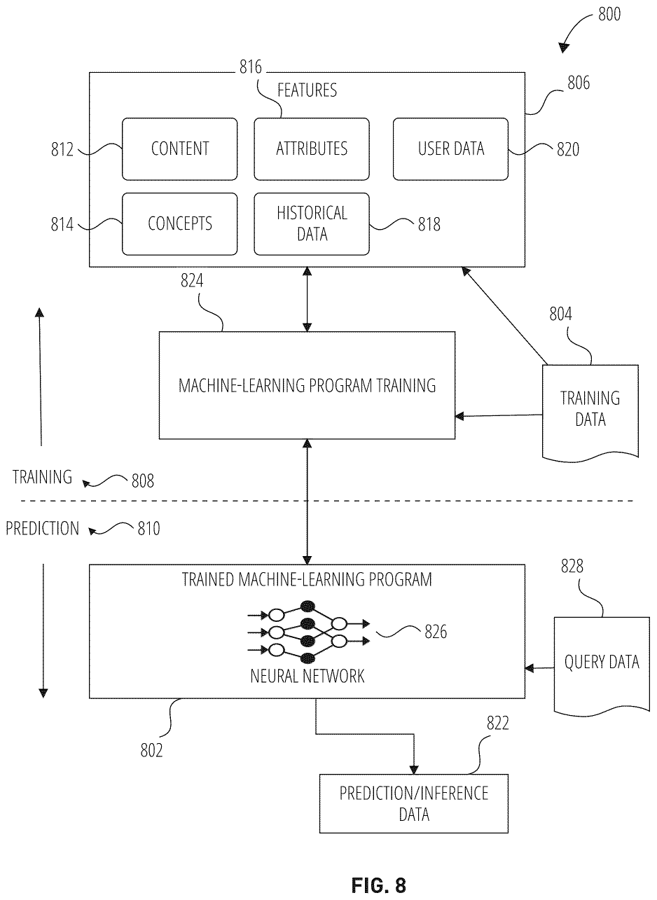

FIG. 8 is a flowchart depicting a machine-learning pipeline 800, according to some examples. The machine-learning pipelines 800 may be used to generate a trained model, for example the trained machine-learning program 802 of FIG. 8, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

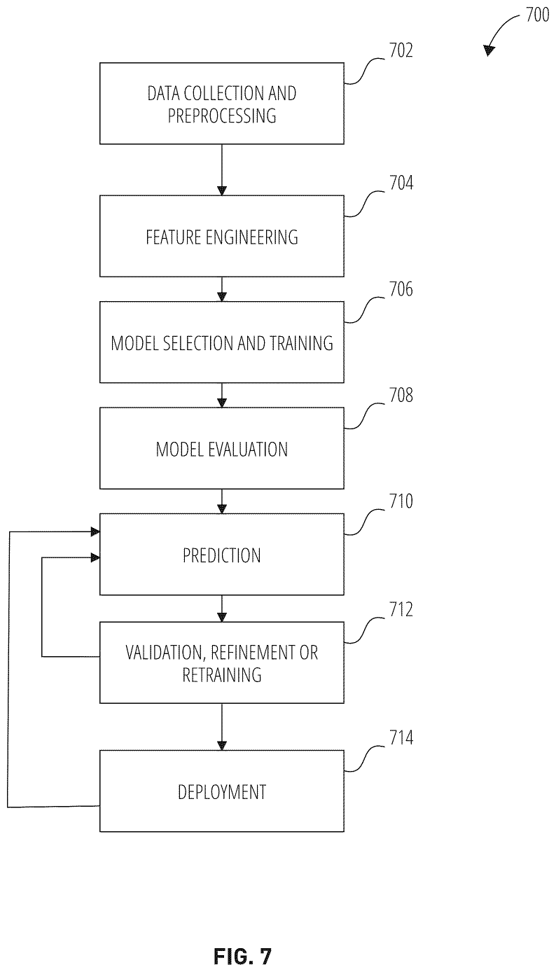

Generating a trained machine-learning program 802 may include multiple types of phases that form part of the machine-learning pipeline 800, including for example the following phases 700 illustrated in FIG. 7:
Data collection and preprocessing 702: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 704: This may include selecting and transforming the training data 804 to create features that are useful for predicting the target variable. Feature engineering may include (1) receiving features 806 (e.g., as structured or labeled data in supervised learning) and/or (2) identifying features 806 (e.g., unstructured or unlabeled data for unsupervised learning) in training data 804.
Model selection and training 706: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 708: This may include evaluating the performance of a trained model (e.g., the trained machine-learning program 802) on a separate testing dataset. This can help determine if the model is overfitting or underfitting and if it is suitable for deployment.
Prediction 710: This involves using a trained model (e.g., trained machine-learning program 802) to generate predictions on new, unseen data.
Validation, refinement or retraining 712: This may include updating a model based on feedback generated from the prediction phase, such as new data or user feedback.
Deployment 714: This may include integrating the trained model (e.g., the trained machine-learning program 802) into a larger system or application, such as a web service, mobile app, or IoT device. This can involve setting up APIs, building a user interface, and ensuring that the model is scalable and can handle large volumes of data.

FIG. 8 illustrates two example phases, namely a training phase 808 (part of the model selection and trainings 806) and a prediction phase 810 (part of prediction 810). Prior to the training phase 808, feature engineering 804 is used to identify features 806. This may include identifying informative, discriminating, and independent features for the effective operation of the trained machine-learning program 802 in pattern recognition, classification, and regression. In some examples, the training data 804 includes labeled data, which is known data for pre-identified features 806 and one or more outcomes.

Each of the features 806 may be a variable or attribute, such as individual measurable property of a process, article, system, or phenomenon represented by a data set (e.g., the training data 804). Features 806 may also be of different types, such as numeric features, strings, vectors, matrices, encodings, and graphs, and may include one or more of content 812, concepts 814, attributes 816, historical data 818 and/or user data 820, merely for example.

Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click through rates, or engagement metrics), or user preferences (such as preferences to certain video, text, or digital content items). Historical data includes past events or trends that can help identify patterns or relationships over time.

In training phases 808, the machine-learning pipeline 800 uses the training data 804 to find correlations among the features 806 that affect a predicted outcome or prediction/inference data 822.

With the training data 804 and the identified features 806, the trained machine-learning program 802 is trained during the training phase 808 during machine-learning program training 824. The machine-learning program training 824 appraises values of the features 806 as they correlate to the training data 804. The result of the training is the trained machine-learning program 802 (e.g., a trained or learned model).

Further, the training phase 808 may involve machine learning, in which the training data 804 is structured (e.g., labeled during preprocessing operations), and the trained machine-learning program 802 implements a relatively simple neural network 826 capable of performing, for example, classification and clustering operations. In other examples, the training phase 808 may involve deep learning, in which the training data 804 is unstructured, and the trained machine-learning program 802 implements a deep neural network 826 that is able to perform both feature extraction and classification/clustering operations.

A neural network 826 may, in some examples, be generated during the training phase 808, and implemented within the trained machine-learning program 802. The neural network 826 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 826 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 826 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 808, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 826 is iteratively trained by adjusting model parameters to minimize a specific loss function or maximize a certain objective. The system can continue to train the neural network 826 by adjusting parameters based on the output of the validation, refinement, or retraining block 812, and rerun the prediction 810 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 826 even after deployment 814 of the neural network 826. The neural network 826 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 810, the trained machine-learning program 802 uses the features 806 for analyzing query data 828 to generate inferences, outcomes, or predictions, as examples of a prediction/inference data 822. For example, during prediction phase 810, the trained machine-learning program 802 is used to generate an output. Query data 828 is provided as an input to the trained machine-learning program 802, and the trained machine-learning program 802 generates the prediction/inference data 822 as output, responsive to receipt of the query data 828. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 802 may be a generative AI model. Generative AI is a term that may refer to any type of artificial intelligence that can create new content from training data 804. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 822 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method performed by one or more hardware processors, the method comprising: accessing electronic interaction data associated with a first user, the interaction data associated with an interaction by the first user with one or more products or services of an entity; accessing transaction log data for the first user, the transaction log data including transactions made by the first user using a transaction instrument; identifying a discrepancy between the electronic interaction data and the transaction log data; determining a projection factor for the first user based on the identified discrepancy; and generating a calibrated electronic interaction dataset by applying the projection factor to the electronic interaction data.

In Example 2, the subject matter of Example 1 includes, wherein at least a portion of the electronic interaction data is captured using a camera on a mobile device of the first user.

In Example 3, the subject matter of Examples 1-2 includes, wherein at least a portion of the electronic interaction data is generated by a point of sale device in a location of the entity.

In Example 4, the subject matter of Examples 1-3 includes, wherein the transaction log data includes purchases made by the first user using the transaction instrument with the entity, wherein the transaction log data includes the entity and time of the transaction, but does not include an itemized list of goods or services purchased.

In Example 5, the subject matter of Examples 1-4 includes, wherein identifying the discrepancy includes identifying a discrepancy in a number of interactions by the first user in the electronic interaction data with the entity and a number of transactions in the transaction log data by the first user with the entity in a period of time.

In Example 6, the subject matter of Examples 1-5 includes, wherein the method further comprises: accessing location data of a mobile device of the first user; and determining a number of visits that the first user visited a location of the entity based on the location data; wherein determining the projection factor is further based on the determined number of visits.

In Example 7, the subject matter of Examples 1-6 includes, wherein the electronic interaction data and the transaction log data is further associated with a plurality of users, wherein the calibrated electronic interaction dataset is for the plurality of users.

In Example 8, the subject matter of Example 7 includes, wherein the plurality of users is located in a particular geographical area.

In Example 9, the subject matter of Examples 7-8 includes, wherein the plurality of users completed a transaction at a particular location of the entity.

In Example 10, the subject matter of Examples 1-9 includes, wherein the electronic interaction data includes receipt data, the method further comprises: identifying a first subset of receipt data of a first receipt type; and identifying a second subset of receipt data of a second receipt type; wherein the projection factor is further based on the first subset of the first receipt type and the second subset of the second receipt type.

In Example 11, the subject matter of Examples 1-10 includes, wherein a first subset and a second subset of the transaction log data is accessed by one or more hardware processors from a first transaction log database and a second transaction log database, respectively, the first transaction log database and the second transaction log database being external to the one or more hardware processors, wherein first subset being in a different data format than the second subset, the method further comprising: normalizing the first subset and the second subset.

In Example 12, the subject matter of Example 11 includes, wherein a first transaction log system associated with the first subset does not have direct communication with a second transaction log system associated with the second subset.

In Example 13, the subject matter of Examples 1-12 includes, wherein identifying the discrepancy, determining the projection factor, and generating the calibrated electronic interaction dataset is based on inputting the electronic interaction data and the transaction log data into a machine learning model, the machine learning model being trained to generate calibrated electronic interaction datasets based on inputted interaction and transaction log data.

In Example 14, the subject matter of Examples 1-13 includes, wherein the method further comprises modifying an ad campaign based on calibrated electronic interaction dataset.

In Example 15, the subject matter of Examples 1-14 includes, wherein determining the projection factor further comprises: accessing publicly available retail revenue data, including an annual or quarterly revenue value for a merchant location from a financial disclosure source; accessing aggregated electronic interaction data and transaction log data for the merchant location; and determining the projection factor based on a ratio between the revenue value from the financial disclosure source and a sum of corresponding transaction values from the interaction data and the transaction log data for the merchant location.

In Example 16, the subject matter of Examples 1-15 includes, wherein determining the projection factor further comprises: identifying a geographic region associated with the first user, the region comprising a zip code or a Designated Market Area (DMA); aggregating transaction log data and interaction data corresponding to the geographic region; and determining the projection factor based on a ratio between a total value from the transaction log data and a total value from the interaction data for the geographic region.

In Example 17, the subject matter of Examples 1-16 includes, wherein determining the projection factor further comprises: aggregating transaction log data for the first user across one or more transaction instruments; aggregating interaction data for the first user; and computing a household-specific projection factor based on a discrepancy between a number of transactions in the transaction log data and a number of interactions in the interaction data for the first user.

In Example 18, the subject matter of Examples 1-17 includes, wherein identifying the discrepancy comprises analyzing geolocation data from a mobile device associated with the first user to determine a number of store visits by the first user, and wherein the projection factor is further based on a difference between the number of store visits and the number of interactions in the electronic interaction data.

Example 19 is a system comprising: at least one processor; and at least one memory component storing instructions that, when executed by the at least one processor, cause the at least one processor to perform operations comprising: accessing electronic interaction data associated with a first user, the interaction data associated with an interaction by the first user with one or more products or services of an entity; accessing transaction log data for the first user, the transaction log data including transactions made by the first user using a transaction instrument; identifying a discrepancy between the electronic interaction data and the transaction log data; determining a projection factor for the first user based on the identified discrepancy; and generating a calibrated electronic interaction dataset by applying the projection factor to the electronic interaction data.

Example 20 is a non-transitory computer-readable storage medium storing instructions that, when executed by at least one processor, cause the at least one processor to perform operations comprising: accessing electronic interaction data associated with a first user, the interaction data associated with an interaction by the first user with one or more products or services of an entity; accessing transaction log data for the first user, the transaction log data including transactions made by the first user using a transaction instrument; identifying a discrepancy between the electronic interaction data and the transaction log data; determining a projection factor for the first user based on the identified discrepancy; and generating a calibrated electronic interaction dataset by applying the projection factor to the electronic interaction data.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

In the example embodiments, it should be understood that the NFT system, the NFT system, and the various devices may be implemented in other manners. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments. In addition, functional units in the example embodiments may be integrated into one processing unit, or each of the units may exist alone physically, or two or more units may be integrated into one unit.

When the functions are implemented in the form of a software functional unit and sold or used as an independent product, the functions may be stored in a computer readable storage medium. Based on such an understanding, the technical solutions of example embodiments may be implemented in the form of a software product. The software product is stored in a storage medium, and includes several instructions for instructing a computing device to perform all or some of the steps or processes of the methods described in the example embodiments. The foregoing storage medium includes any medium that can store program code, such as a universal serial bus flash drive, removable hard disk, read only memory, random access memory, magnetic disc, and/or an optical disc.

In the described methods or block diagrams, boxes may represent events, steps, functions, processes, modules, messages, and/or state based operations, etc. While some of the example embodiments have been described as occurring in a particular order, some of the steps or processes may be performed in a different order provided that the result of the changed order of any given step will not prevent or impair the occurrence of subsequent steps. Furthermore, some of the messages or steps described may be removed or combined in other embodiments, and some of the messages or steps describe herein may be separated into a number of sub-messages or sub-steps in other embodiments. Even further, some or all of the steps may be repeated, as necessary. Elements described as methods, steps, or processes similarly apply to systems, subsystems, or subcomponents, and vice versa. Reference to such a word as sending or receiving could be interchanged depending on the perspective of the particulars device. The described embodiments are considered to be illustrative and not restrictive. Example embodiments described as methods would similarly apply to systems, subsystems, or devices, and vice versa.

The various example embodiments are merely examples and are in no way meant to limit the scope of this disclosure. Variations of the innovations describe herein will be apparent to persons of ordinary skill in the art, such variations being within the intended scope. In particular features from one or more of the example embodiments may be selected to create alternative embodiments comprised of a sub-combination of features which may not be explicitly described. In addition, features from one or more of the described example embodiments may be selected and combined to create alternative example embodiments comprised of a combination of features which may not be explicitly described. Features suitable for such combinations and sub-combinations would be readily apparent a person skilled in the art. The subject matter describe herein intends to cover all suitable changes in technology.

1. A method performed by one or more hardware processors, the method comprising:
accessing electronic interaction data associated with a first user, the electronic interaction data associated with an interaction by the first user with one or more products or services of an entity;
accessing transaction log data for the first user, the transaction log data including transactions made by the first user using a transaction instrument;
normalizing the electronic interaction data and the transaction log data to a common data schema by:
reconciling field names associated with the electronic interaction data and the transaction log data;
standardizing date and time formats associated with the electronic interaction data and the transaction log data; or
mapping merchant identifiers from the electronic interaction data and the transaction log data to a shared merchant taxonomy;
identifying a discrepancy between the normalized electronic interaction data and the normalized transaction log data;
determining a projection factor for the first user based on the identified discrepancy;
generating a calibrated electronic interaction dataset by applying the projection factor to the electronic interaction data, wherein the calibrated electronic interaction dataset reconciles missing interactions represented in the transaction log data but absent from the electronic interaction data: and
based on the calibrated electronic interaction dataset, cause modification of a bid for an content media campaign, wherein the content media campaign is configured to cause display of content media.

2. The method of claim 1, wherein at least a portion of the electronic interaction data is captured using a camera on a mobile device of the first user.

3. The method of claim 1, wherein at least a portion of the electronic interaction data is generated by a point of sale device in a location of the entity.

4. The method of claim 1, wherein the transaction log data includes purchases made by the first user using the transaction instrument with the entity, wherein the transaction log data includes the entity and time of the transaction, but does not include an itemized list of goods or services purchased.

5. The method of claim 1, wherein the discrepancy includes a number of interactions by the first user in the electronic interaction data with the entity and a number of transactions in the transaction log data by the first user with the entity in a period of time.

6. The method of claim 1, further comprising:
accessing location data of a mobile device of the first user; and
determining a number of visits that the first user visited a location of the entity based on the location data;
wherein determining the projection factor is further based on the determined number of visits.

7. The method of claim 1, wherein the electronic interaction data and the transaction log data is further associated with a plurality of users, wherein the calibrated electronic interaction dataset is for the plurality of users.

8. The method of claim 7, wherein the plurality of users is located in a particular geographical area.

9. The method of claim 7, wherein the plurality of users completed a transaction at a particular location of the entity.

10. The method of claim 1, wherein the electronic interaction data includes receipt data, the method further comprises:
identifying a first subset of receipt data of a first receipt type; and
identifying a second subset of receipt data of a second receipt type;
wherein the projection factor is further based on the first subset of the first receipt type and the second subset of the second receipt type.

11. The method of claim 1, wherein a first subset and a second subset of the transaction log data is accessed by one or more hardware processors from a first transaction log database and a second transaction log database, respectively,
the first transaction log database and the second transaction log database being external to the one or more hardware processors,
wherein first subset being in a different data format than the second subset, the method further comprising:
normalizing the first subset and the second subset.

12. The method of claim 11, wherein a first transaction log system associated with the first subset does not have direct communication with a second transaction log system associated with the second subset.

13. The method of claim 1, wherein identifying the discrepancy, determining the projection factor, and generating the calibrated electronic interaction dataset is based on inputting the electronic interaction data and the transaction log data into a machine learning model, the machine learning model being trained to generate calibrated electronic interaction datasets based on inputted interaction and transaction log data.

14. The method of claim 1, wherein the method further comprises modifying an ad campaign based on calibrated electronic interaction dataset.

15. The method of claim 1, wherein determining the projection factor further comprises:
accessing publicly available retail revenue data, including an annual or quarterly revenue value for a merchant location from a financial disclosure source;
accessing aggregated electronic interaction data and transaction log data for the merchant location; and
determining the projection factor based on a ratio between the revenue value from the financial disclosure source and a sum of corresponding transaction values from the interaction data and the transaction log data for the merchant location.

16. The method of claim 1, wherein determining the projection factor further comprises:
identifying a geographic region associated with the first user, the region comprising a zip code or a Designated Market Area (DMA);
aggregating transaction log data and interaction data corresponding to the geographic region; and
determining the projection factor based on a ratio between a total value from the transaction log data and a total value from the interaction data for the geographic region.

17. The method of claim 1, wherein determining the projection factor further comprises:
aggregating transaction log data for the first user across one or more transaction instruments;
aggregating interaction data for the first user; and
computing a household-specific projection factor based on a discrepancy between a number of transactions in the transaction log data and a number of interactions in the interaction data for the first user.

18. The method of claim 1, wherein identifying the discrepancy comprises analyzing geolocation data from a mobile device associated with the first user to determine a number of store visits by the first user, and wherein the projection factor is further based on a difference between the number of store visits and a number of interactions in the electronic interaction data.

19. A system comprising:
at least one processor; and
at least one memory component storing instructions that, when executed by the at least one processor, cause the at least one processor to perform operations comprising:
accessing electronic interaction data associated with a first user, the electronic interaction data associated with an interaction by the first user with one or more products or services of an entity;
accessing transaction log data for the first user, the transaction log data including transactions made by the first user using a transaction instrument;
normalizing the electronic interaction data and the transaction log data to a common data schema by:
reconciling field names associated with the electronic interaction data and the transaction log data;
standardizing date and time formats associated with the electronic interaction data and the transaction log data; or
mapping merchant identifiers from the electronic interaction data and the transaction log data to a shared merchant taxonomy;
identifying a discrepancy between the normalized electronic interaction data and the normalized transaction log data;
determining a projection factor for the first user based on the identified discrepancy;
generating a calibrated electronic interaction dataset by applying the projection factor to the electronic interaction data, wherein the calibrated electronic interaction dataset reconciles missing interactions represented in the transaction log data but absent from the electronic interaction data: and
based on the calibrated electronic interaction dataset, cause modification of a bid for an content media campaign, wherein the content media campaign is configured to cause display of content media.

20. A non-transitory computer-readable storage medium storing instructions that, when executed by at least one processor, cause the at least one processor to perform operations comprising:
accessing electronic interaction data associated with a first user, the electronic interaction data associated with an interaction by the first user with one or more products or services of an entity;
accessing transaction log data for the first user, the transaction log data including transactions made by the first user using a transaction instrument;
normalizing the electronic interaction data and the transaction log data to a common data schema by:
reconciling field names associated with the electronic interaction data and the transaction log data;
standardizing date and time formats associated with the electronic interaction data and the transaction log data; or
mapping merchant identifiers from the electronic interaction data and the transaction log data to a shared merchant taxonomy;
identifying a discrepancy between the normalized electronic interaction data and the normalized transaction log data;
determining a projection factor for the first user based on the identified discrepancy;
generating a calibrated electronic interaction dataset by applying the projection factor to the electronic interaction data, wherein the calibrated electronic interaction dataset reconciles missing interactions represented in the transaction log data but absent from the electronic interaction data; and
based on the calibrated electronic interaction dataset, cause modification of a bid for an content media campaign, wherein the content media campaign is configured to cause display of content media.
